(19) United States
(12) Patent Application Publication
(10) Pub. No.: US 2013/0335189 A1
(43) Pub. Date: Dec. 19, 2013

(54) COMPONENT WITH COUNTERMEASURE AGAINST STATIC ELECTRICITY AND METHOD OF MANUFACTURING SAME

(71) Applicants: Yuuichi Abe, Hokkaido (JP); Kenji Oka, Hokkaido (JP); Fuyuki Abe, Kyoto (JP); Kazuhiro Miura, Hokkaido (JP); Mikinori Amisawa, Hokkaido (JP); Atsumi Miyakawa, Hokkaido (JP); Takahiro Senshu, Hokkaido (JP); Yuji Yamagishi, Hokkaido (JP); Jun Ootsuki, Hokkaido (JP)

(72) Inventors: Yuuichi Abe, Hokkaido (JP); Kenji Oka, Hokkaido (JP); Fuyuki Abe, Kyoto (JP); Kazuhiro Miura, Hokkaido (JP); Mikinori Amisawa, Hokkaido (JP); Atsumi Miyakawa, Hokkaido (JP); Takahiro Senshu, Hokkaido (JP); Yuji Yamagishi, Hokkaido (JP); Jun Ootsuki, Hokkaido (JP)

(73) Assignee: PANASONIC CORPORATION, Osaka (JP)

(21) Appl. No.: 13/985,473

(22) PCT Filed: Apr. 16, 2012
(86) PCT No.: PCT/JP2012/002616

§ 371 Date: Aug. 14, 2013

(30) Foreign Application Priority Data
Apr. 26, 2011 (JP) 2011-097799

(51) Int. Cl. H02H 9/04; H01C 17/30

(52) U.S. Cl. CPC H02H 9/04; H01C 17/30
USPC 338/21; 29/610.1

(57) ABSTRACT

An electrostatic discharge (ESD) protector includes a first high heat-conductive substrate, a second high heat-conductive substrate, a varistor layer, and a plurality of via-hole electrodes. The first high heat-conductive substrate is provided with a plurality of first through-holes. The second high heat-conductive substrate is provided with a plurality of second through-holes. The varistor layer that is mainly composed of zinc oxide is disposed between the first high heat-conductive substrate and the second high heat-conductive substrate. The varistor layer includes internal electrodes. Each of via-hole electrodes penetrates the varistor layer and fills both one of the first through-holes and one of the second through-holes to couple both the ones to each other.

### TECHNICAL FIELD

The present invention relates to electrostatic discharge (ESD) protectors used in a wide range of electronic equipment and to methods for manufacturing the same.

### BACKGROUND ART

In recent years, rapid progress in miniaturization of electronic equipment has entailed a reduction in withstand voltages of various electronic components that configure circuits of the electronic equipment. This tends to increase failures and troubles of the electronic equipment due to destruction of the various electronic components, in particular semiconductor devices, which is caused by such as electrostatic pulses generated when a human body comes in contact with a conductive part of the electronic equipment.

Moreover, a light-emitting diode, a kind of semiconductor device, has lower performance regarding a withstand voltage against electrostatic pulses, whereas it has been required to have higher luminance leading to larger heat generation. Therefore, countermeasures against the heat generation have been demanded as well as the withstand voltage.

For these demands, an electrostatic discharge (ESD) protector shown in FIG. 6 has been proposed. The ESD protector includes ceramic substrate 1 made of alumina, varistor layer 2 disposed on the substrate, glass-ceramic layer 3 disposed on the varistor layer, and external electrodes 4 disposed on the glass-ceramic layer. Glass-ceramic layer 3 is disposed to protect varistor layer 2 against an environment and formation of plated-layers on external electrodes 4 (see Patent Literature 1, for example).

### CITATION LIST

### Patent Literature

PLT 1: Japanese Patent Unexamined Publication No. 2008-270325

### SUMMARY OF THE INVENTION

The present invention is intended to provide an electrostatic discharge (ESD) protector that features small warpage of a substrate thereof and high heat conduction, and a method for manufacturing the protector. The ESD protector of the invention includes a first high heat-conductive substrate, a second high heat-conductive substrate, a varistor layer, and a pair of via-hole electrodes. The first high heat-conductive substrate is provided with two of first through-holes. The second high heat-conductive substrate is provided with two of second through-holes. The varistor layer, which is mainly composed of zinc oxide, is disposed between the first high heat-conductive substrate and the second high heat-conductive substrate. The varistor layer includes, in the inside thereof, a pair of internal electrodes which are insulated from each other. Each of the via-hole electrodes penetrates through the varistor layer and fills both one of the first through-holes and one of the second through-holes to couple both the ones to each other. The via-hole electrodes are respectively coupled with the internal electrodes. With this configuration, it is possible to prevent occurrence of warpage when firing the varistor layer, and to provide high heat conductivity.

### BRIEF DESCRIPTION OF DRAWINGS

FIG. 1 is a cross-sectional view of an electrostatic discharge (ESD) protector according to an embodiment of the present invention.

FIG. 2A is a conceptual plan view of an ESD protector according to the embodiment of the invention, which illustrates a shape of internal electrodes thereof and an arrangement of via-hole electrodes thereof.

FIG. 2B is a conceptual plan view of an ESD protector according to the embodiment of the invention, which illustrates a shape of internal electrodes and an arrangement of via-hole electrodes.

FIG. 2C is a conceptual plan view of an ESD protector according to the embodiment of the invention, which illustrates a shape of internal electrodes and an arrangement of via-hole electrodes.

FIG. 2D is a conceptual plan view of an ESD protector according to the embodiment of the invention, which illustrates a shape of internal electrodes and an arrangement of via-hole electrodes.

FIG. 3A is a view illustrating a manufacturing step in a manufacturing procedure of an ESD protector according to the embodiment of the invention.

FIG. 3B is a view illustrating a manufacturing step of the ESD protector, which follows that of FIG. 3A.

FIG. 3C is a view illustrating a manufacturing step of the ESD protector, which follows that of FIG. 3B.

FIG. 3D is a view illustrating a manufacturing step of the ESD protector, which follows that of FIG. 3C.

FIG. 3E is a view illustrating a manufacturing step of the ESD protector, which follows that of FIG. 3D.

FIG. 3F is a view illustrating a manufacturing step of the ESD protector, which follows that of FIG. 3E.

FIG. 3G is a view illustrating a manufacturing step of the ESD protector, which follows that of FIG. 3F.

FIG. 3H is a view illustrating a manufacturing step of the ESD protector, which follows that of FIG. 3G.

FIG. 4A is a view illustrating a manufacturing step in another manufacturing procedure of an ESD protector according to the embodiment of the invention.

FIG. 4B is a view illustrating a manufacturing step of the ESD protector, which follows that of FIG. 4A.

FIG. 4C is a view illustrating a manufacturing step of the ESD protector, which follows that of FIG. 4B.

FIG. 4D is a view illustrating a manufacturing step of the ESD protector, which follows that of FIG. 4C.

FIG. 4E is a view illustrating a manufacturing step of the ESD protector, which follows that of FIG. 4D.

FIG. 4F is a view illustrating a manufacturing step of the ESD protector, which follows that of FIG. 4E.

FIG. 4G is a view illustrating a manufacturing step of the ESD protector, which follows that of FIG. 4F.

FIG. 4H is a view illustrating a manufacturing step of the ESD protector, which follows that of FIG. 4G.

FIG. 5A is a view illustrating a manufacturing step in further another manufacturing procedure of an ESD protector according to the embodiment of the invention.

FIG. 5B is a view illustrating a manufacturing step of the ESD protector, which follows that of FIG. 5A.

FIG. 5C is a view illustrating a manufacturing step of the ESD protector, which follows that of FIG. 5B.

FIG. 5D is a view illustrating a manufacturing step of the ESD protector, which follows that of FIG. 5C.

FIG. 5E is a view illustrating a manufacturing step of the ESD protector, which follows that of FIG. 5D.

FIG. 5F is a view illustrating a manufacturing step of the ESD protector, which follows that of FIG. 5E.

FIG. 5G is a view illustrating a manufacturing step of the ESD protector, which follows that of FIG. 5F.

FIG. 5H is a view illustrating a manufacturing step of the ESD protector, which follows that of FIG. 5G.

FIG. 6 is a cross-sectional view of a conventional ESD protector.

### DESCRIPTION OF EMBODIMENTS

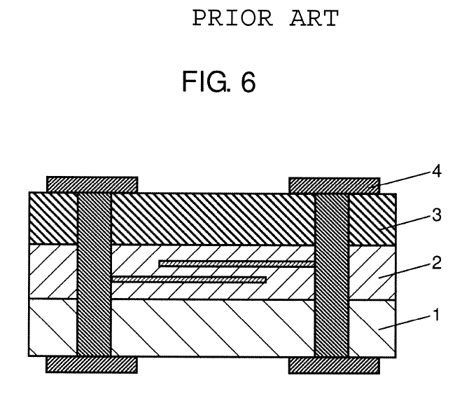

In the electrostatic discharge (ESD) protector shown in FIG. 6, the substrate thereof tends to suffer from warpage when firing a glass ceramic layer thereof. The warpage of the substrate is not a serious problem when the ESD protector is electrically connected to a light-emitting diode device by wire bonding after the light-emitting diode device has been mounted on a circuit board. However, when the light-emitting diode device is mounted by flip-chip bonding on the ESD protector for miniaturization, the warpage of the substrate is a serious problem. Moreover, in general, glass ceramic layers have lower heat conductivity than ceramic substrates made of alumina or the like. For this reason, it is difficult to efficiently dissipate heat generated in the light-emitting diode device.

Hereinafter, descriptions will be made regarding an electrostatic discharge (ESD) protector that can overcome the problem described above and regarding a method for manufacturing it.

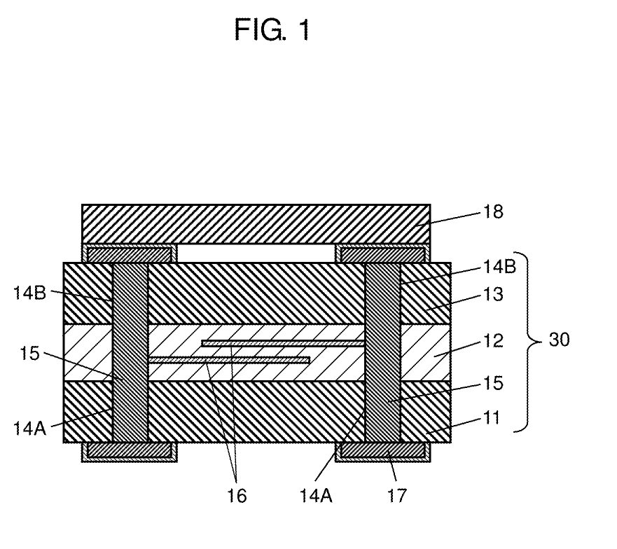

FIG. 1 is a cross-sectional view of an ESD protector according to an embodiment of the present invention. ESD protector 30 includes first high heat-conductive substrate (referred to as “substrate”, hereinafter) 11, second high heat-conductive substrate (referred to as “substrate”, hereinafter) 13, varistor layer 12, and via-hole electrodes 15. In substrate 11, two of first through-holes (referred to as “holes”, hereinafter) 14A are disposed. In substrate 13, two of second through-holes (referred to as “holes”, hereinafter) 14B are disposed. Varistor layer 12 mainly composed of zinc oxide is disposed between substrate 11 and substrate 13. Varistor layer 12 includes, in the inside thereof, a pair of internal electrodes 16 that are insulated from each other. Each of via-hole electrodes 15 penetrates through varistor layer 12 and fills both one of holes 14A and one of holes 14B to couple the ones each other. Moreover, via-hole electrodes 15 are respectively coupled with internal electrodes 16. That is, via-hole electrodes 15 include a first via-hole electrode and a second via-hole electrode, while internal electrodes 16 include a first internal electrode and a second internal electrode. The first via-hole electrode is coupled with the first internal electrode, while the second via-hole electrode is coupled with the second internal electrode.

Substrates 11 and 13 are, for example, a sintered alumina plate with a purity of 96% or greater. Substrate 11 has, for example, a planar shape of approximately 3 mm×3 mm with a thickness of approximately 0.12 mm. Substrate 13 has, for example, a planar shape of approximately 3 mm×3 mm with a thickness of approximately 0.16 mm. The thickness of varistor layer 12 is approximately 0.2 mm, for example.

Note that the high heat-conductive substrates stated herein are insulating substrates with a heat conductivity of 18 W/m·K or greater. For substrates 11 and 13, sintered plates of aluminum nitride, silicon nitride, silicon carbide, etc. may be employed other than the alumina ones.

In each of substrates 11 and 13, two of holes 14A and 14B with a diameter of approximately 0.2 mm are disposed, respectively, at the same corresponding positions for the each. Also, varistor layer 12 has through-holes at the same corresponding positions as those described above. Connecting these corresponding through-holes gives connected through-holes which penetrate through from the lower surface of substrate 11 to the upper surface of substrate 13, respectively. By filling a silver-palladium paste in the thus-connected through-holes, via-hole electrodes 15 are formed so as to penetrate through from the lower surface of substrate 11 to the upper surface of substrate 13, respectively.

Varistor layer 12 is formed by stacking layers, i.e. .layers with a main component of zinc oxide and silver-palladium paste layers formed by printing which are to be processed into a pair of internal electrodes 16. Here, the “main component” described herein implies that the content of the component is necessary to exhibit varistor characteristics. Specifically, the content is 70 weight % or greater, for example.

Internal electrodes 16 are insulated from each other, and each of internal electrodes 16 is electrically coupled with one of via-hole electrodes 15. Moreover, on the outer surfaces of substrates 11 and 13, external electrodes 17 are provided so as to be respectively coupled with via-hole electrodes 15. External electrodes 17 disposed on substrate 13 serve as electrodes for mounting semiconductor device 18 on the protector, such as a light-emitting diode, thereon. On the other hand, external electrodes 17 disposed on substrate 11 serve as electrodes for mounting the protector on a printed board. Incidentally, external electrodes 17 are formed by firing the silver-palladium paste, followed by plating it with nickel, copper, gold, or the like.

As described above, varistor layer 12 is formed between sintered substrates 11 and 13. With this configuration, the warpage of ESD protector 30 as a whole is suppressed. Moreover, the heat generated in semiconductor device 18 is efficiently transferred because both alumina and zinc oxide have a heat conductivity of not lower than approximately 20 W/m·K. In addition, both the upper and lower surfaces of varistor layer 12 are surrounded by sintered substrates 11 and 13. This prevents trace components including bismuth which configure varistor layer 12 from evaporating and getting lost during the firing of varistor layer 12. Consequently, it is possible to manufacture ESD protector 30 with a stable varistor voltage.

An electrostatic discharge protector with a planer shape of approximately 3 mm×3 mm is conventionally configured with ceramic substrate 1 of approximately 0.26 mm in thickness, varistor layer 2 of approximately 0.2 mm in thickness, and glass-ceramic layer 3 of approximately 0.02 mm in thickness. This conventional configuration will cause a warpage of approximately 0.2 mm that follows the firing of varistor layer 2. In contrast, in ESD protector 30, the warpage is approximately 0.03 mm, so that the flatness is remarkably improved. The warpage in this case results from substrates 11 and 13 per se. That is, the firing of varistor layer 2 causes substantially no warpage. Moreover, the heat conductivity of ESD protector 30 is approximately two times higher than that of the ESD protector with the conventional configuration described above.

Moreover, in the case where a light-emitting diode is mounted as semiconductor device 18, the reflectivity of a mounting surface on which the light-emitting diode is mounted is required to be increased. As the alumina substrate is made thinner, its optical transmittance increases to make the underlying varistor layer visible, resulting in a decrease in reflectivity of the substrate. For this reason, in ESD protector 30, the thickness of substrate 13 on which semiconductor device 18 is mounted is preferably larger than that of substrate 11. Use of such substrates 11 and 13 allows the increased reflectivity of the mounting surface for semiconductor device 18. As a result, this configuration is more preferable, in particular for applications where a light-emitting diode is mounted.

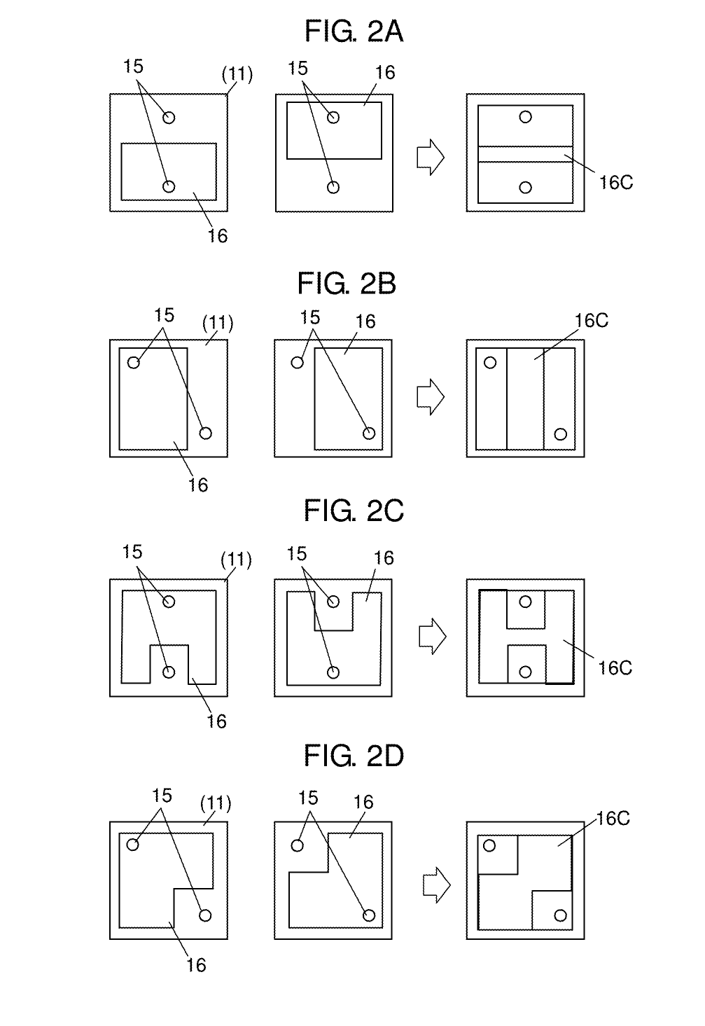

Next, referring to FIGS. 2A to 2D, descriptions will be made regarding preferable configurations of both the shape of internal electrodes 16 and the arrangement of via-hole electrodes 15. FIGS. 2A to 2D are conceptual plan views that illustrate shapes of internal electrodes 16 and arrangements of via-hole electrodes 15.

In general, as shown in FIG. 2A, for substrates 11 and 13 that have a square planar shape, via-hole electrodes 15 are formed near the opposite sides of the square and internal electrodes 16 are formed in a rectangular shape. In this way, the internal structure is determined from a quality point of view such that certain distances are kept between the outer periphery of ESD protector 30, internal electrodes 16, and via-hole electrodes 15. However, in the case of a miniaturized structure, overlapping portion 16C of internal electrodes 16 is greatly reduced in size. Comparing the areas of overlapping portions 16C in maximized-area designs, a miniaturization of the planar shape from 3 mm×3 mm to 2 mm>2 mm will reduce the area of the overlapping portion of internal electrodes 16 to approximately ⅕ times, for example. A further miniaturization of the planar shape to 1.5 mm×1.5 mm will further reduce the area of overlapping portion 16C to approximately 1/20 times or less. For this reason, for achieving a comparable varistor voltage, a multilayered structure is necessary. However, such a multilayered structure leads to lower productivity and an increase in cost. In an extreme case, product design per se becomes impossible in view of product thickness-dimension specifications.

In contrast, as shown in FIG. 2B, via-hole electrodes 15 are arranged at diagonal positions opposite to each other, resulting in an approximately doubling of the area of overlapping portion 16C. In this way, it is preferable to arrange via-hole electrodes 15 at positions most away from each other in the plane direction of substrate 11. In the example shown in FIG. 2B, the description is made for the case of substrate 11 having the square planar shape. However, even for cases of the substrate having other shapes, what is only required is to arrange via-hole electrodes 15 at positions most away from each other in the plane direction of substrate 11.

Moreover, as shown in FIGS. 2C and 2D, the shape of each of internal electrodes 16 may be configured to surround one of via-hole electrodes 15, where the one is not coupled with the respective one of internal electrodes 16. With the configurations shown in FIGS. 2C and 2D, the area of overlapping portion 16C is approximately four times larger than that of the configuration shown in FIG. 2A.

By employing the shape of internal electrodes 16 and the arrangement of via-hole electrodes 15 as described above, it is possible to miniaturize ESD protector 30 in size, with the varistor characteristics being kept.

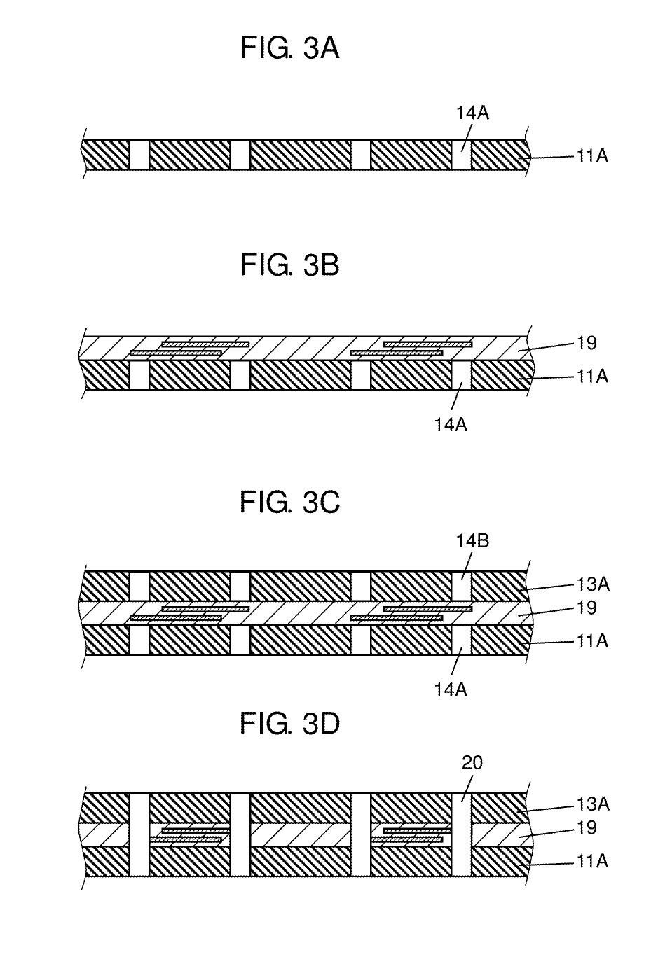

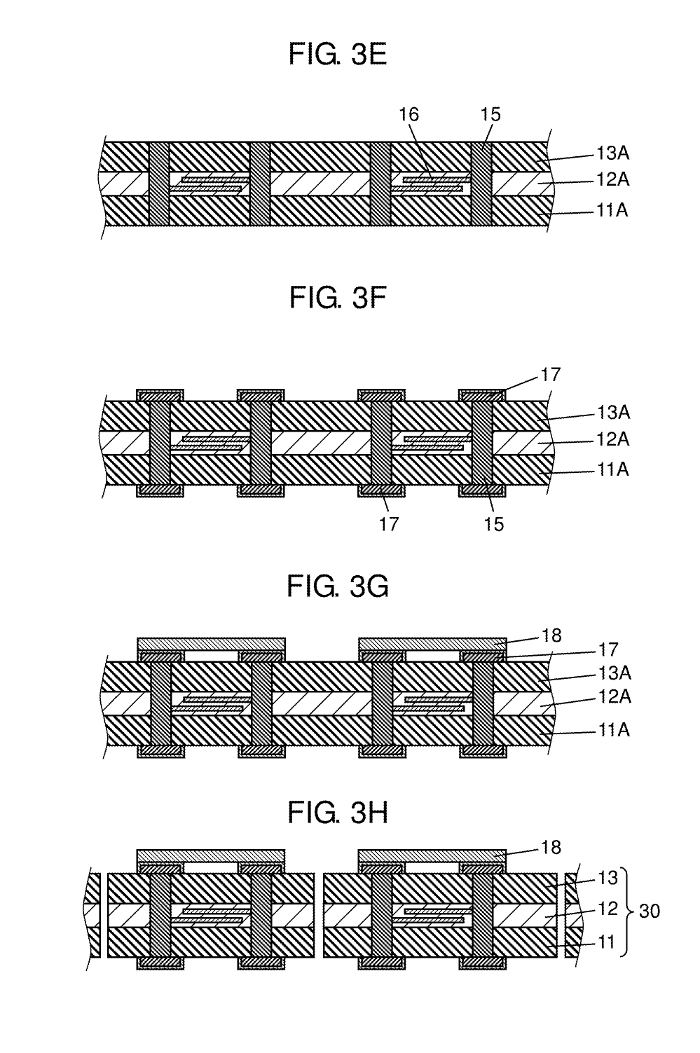

Next, descriptions will be made regarding a method for manufacturing the electrostatic discharge (ESD) protector, according to the embodiment of the present invention. In the following descriptions, there are employed first high-heat-conductive large substrate (referred to as “substrate”, hereinafter) 11A that is n-fold larger in the planar dimension than substrate 11, and second high-heat-conductive large substrate (referred to as “substrate”, hereinafter) 13A that is n-fold larger in the planar dimension than substrate 13. Then, a method for dividing the resulting product, in which n-pieces of ESD protectors 30 have been configured, into individual pieces will be described. FIGS. 3A to 3H are views for illustrating the method for manufacturing the ESD protector according to the embodiment of the invention.

First, as shown in FIG. 3A, a plurality of holes 14A are formed, with such as a laser, at predetermined positions in substrate 11A that is an alumina plate with a thickness of approximately 0.14 mm. The size of holes 14A is approximately 0.2 mm in diameter. In the same manner, holes 14B are formed in substrate 13A as well that is an alumina plate with a thickness of approximately 0.14 mm. Although, there is no need for using the same plates for substrate 11A and substrate 13A, it is preferable to use plates with a small difference of coefficient of linear thermal expansion, and more preferably made of the same material, in order to achieve small warpage. Note, however, that holes 14A and holes 14B must be arranged at the same corresponding positions in substrates 11A and 13B, respectively. Accordingly, taking the same configuration for both the substrates eliminates the need for separate-controlling of substrates 11A and 13B, which results in an increase in mass-productivity.

Next, as shown in FIG. 3B, yet-to-be-fired layer 19 is formed on substrate 11A. Yet-to-be-fired layer 19 is to be processed into varistor layer 12A shown in FIG. 3E. Yet-to-be-fired layer 19 is configured by stacking layers, i.e. layers mainly composed of zinc oxide, and layers formed by printing a silver-palladium paste which are to be processed into internal electrodes 16. Yet-to-be-fired layer 19 may be either one formed by printing the layers on substrate 11, or one formed by laminating a separately-prepared sheet, and being stacked onto substrate 11. Moreover, the pattern of each of the layers for forming internal electrodes 16 is preferably formed so as to cover hole 14A disposed for via-hole electrode 15 to be coupled with the respective one of internal electrodes 16, as viewed from the stacking direction. With this configuration, it is possible to improve the connectivity between internal electrode 16 and via-hole electrode 15.

Next, as shown in FIG. 3C, substrate 13A is laid on yet-to-be-fired layer 19, and then they are pressed together to integrate substrate 11A, yet-to-be-fired layer 19, and substrate 13A. At this time, substrate 13A is placed such that holes 14A are located at the same positions as those of corresponding holes 14B.

Next, as shown in FIG. 3D, parts of yet-to-be-fired layer 19, which are present between holes 14A and holes 14B, are removed by irradiating the parts with laser light via holes 14A and holes 14B. In this way, via- holes 20 are formed so as to penetrate through from holes 14A formed in substrate 11A to holes 14B formed in substrate 13A. Then, the resulting stacked body is fired in a furnace for yet-to-be-fired layer 19 to undergo heat treatment. Because yet-to-be-fired layer 19 contains a plasticizer and the like, the firing is carried out in such a manner that the firing temperature is increased and kept at 105 to 175° C. to remove the plasticizer and the like, and then the temperature is further increased up to approximately 925° C. to form varistor layer 12A.

Usually, in the case where yet-to-be-fired layer 19 is sandwiched between such flat plates, i.e. substrates 11A and 13A, it is difficult for the layer be fired well because of remaining components of the plasticizer and the like which cannot be sufficiently removed. On the other hand, in the embodiment, substrates 11A and 13A are provided with a large number of holes 14A and 14B, which allows emissions of the components including the plasticizer via holes 14A and 14B. This results in the well⁻formation of varistor layer 12A.

Moreover, use of the same alumina substrates for substrates 11A and 13A allows prevention of the occurrence of warpage due to the firing. For efficient emissions of the plasticizer and the like, the ratio of the areas of holes 14A and 14B to those of substrates 11A and 13A is preferably made large, respectively. The ratio of 0.06% or greater allows sufficient emissions. Note, however, that an excessively large ratio will cause a decrease in mechanical strength of ESD protector 30; the ratio is preferably set to be 12% or less.

After that, the thus-fired stacked body may be immersed in an alkaline solution, such as an aqueous solution of sodium hydroxide, to etch parts of the zinc oxide present at the peripheries of via-holes 20. The silver-palladium layers that configure internal electrodes 16 are not etched with the alkaline solution. Accordingly, this process allows the internal electrodes to protrude through the wall surfaces of varistor layer 12A at the peripheries of via-holes 20. As a result, when via-hole electrodes 15 are formed in via-holes 20, it is possible to further improve the connectivity between internal electrodes 16 and via-hole electrodes 15.

Next, as shown in FIG. 3E, via-holes 20 are filled with a silver-palladium paste and then fired to form via-hole electrodes 15 that penetrate through from the lower surface of substrate 11 to the upper surface of substrate 13.

Then, as shown in FIG. 3F, on the surfaces of substrate 11A and substrate 13B, external electrodes 17 are formed that are coupled with respective via-hole electrodes 15. External electrodes 17 are formed by copper-plating and patterning, followed by plating to form nickel and gold layers thereon. In this process, because the layer of zinc oxide is not exposed from any area except for the peripheries of substrates 11A and 13B, varistor layer 12A does not suffer from any influence, such as corrosion, of the plating solutions.

Next, as shown in FIG. 3G, semiconductor devices 18 are mounted on external electrodes 17 disposed on the surface of substrate 13A. Between the terminals of each of semiconductor devices 18, varistor layer 12A is coupled. Consequently, it is possible to prevent destruction of semiconductor device 18 due to static electricity and the like.

Finally, the resulting integrated product in which a plurality (n-pieces) of the devices are configured is divided, by dicing, into individual pieces. This completes ESD protector 30 with semiconductor device 18 mounted thereon, as shown in FIG. 3H.

Note that, in FIG. 3D, although the parts of yet-to-be-fired layer 19 located between holes 14A and holes 14B are removed with the laser light, any method other than the laser light may be applied to remove the parts. For example, blasting (micro-blasting) may be applied.

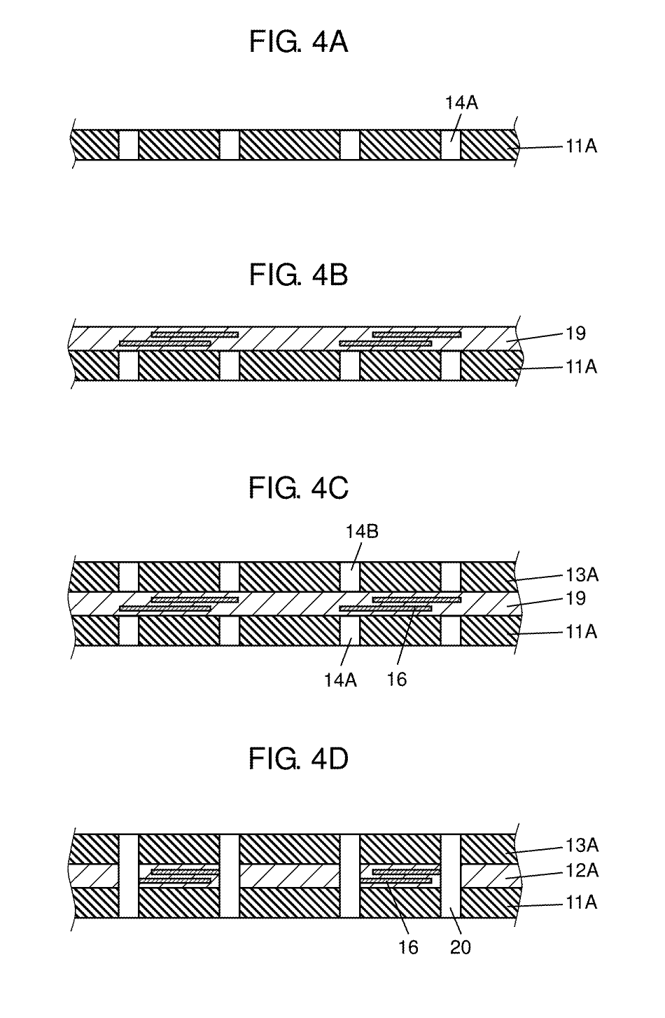

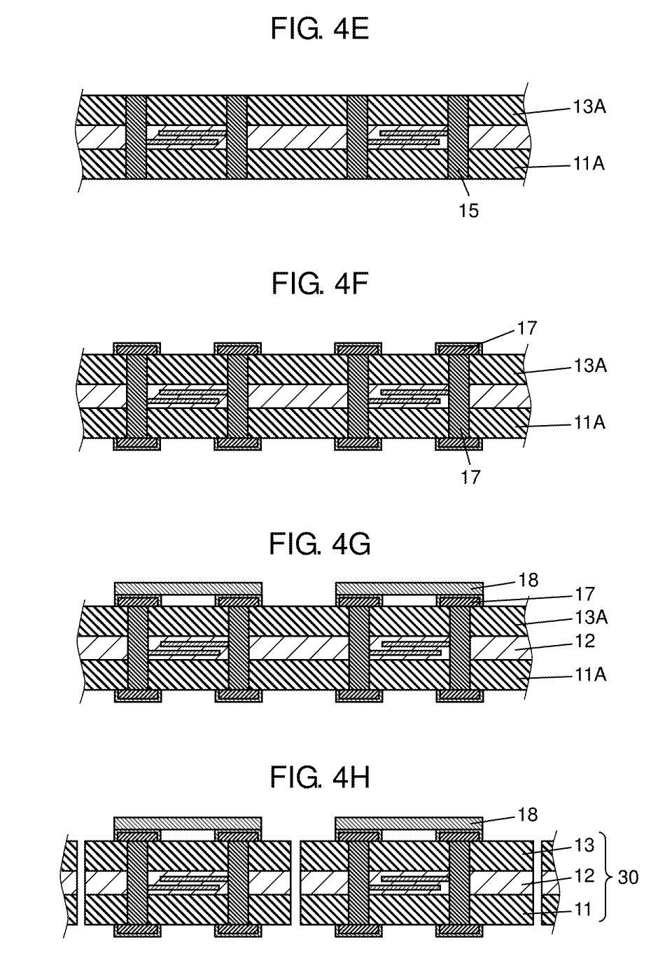

Next, descriptions will be made regarding another method for manufacturing the electrostatic discharge (ESD) protector, according to the embodiment of the present invention. FIGS. 4A to 4H are views for illustrating the another method for manufacturing the ESD protector, according to the embodiment of the invention.

First, as shown in FIG. 4A, a plurality of holes 14A are formed in substrate 11A, while holes 14B are formed in substrate 13. Next, as shown in FIG. 4B, on substrate 11, yet-to-be-fired layer 19 is formed that is to be processed into varistor layer 12A. Next, as shown in FIG. 4C, substrate 13 is laid on yet-to-be-fired layer 19, and then they are pressed together to integrate substrate 11, yet-to-be-fired layer 19, and substrate 13. The steps described above are the same as those described with reference to FIG. 3A to 3C; therefore, detailed descriptions thereof are omitted.

After that, the resulting integrated stacked- body is placed in a furnace and yet-to-be-fired layer 19 is subjected to heat treatment to form varistor layer 12A. In this case as well, components such as a plasticizer of yet-to-be-fired layer 19 can be emitted via holes 14A and 14B.

Next, as shown in FIG. 4D, the thus-fired stacked body is immersed in an alkaline solution, such as an aqueous solution of sodium hydroxide, to etch the zinc oxide of varistor layer 12A located between holes 14A and holes 14B. With this step, via-holes 20 are formed that penetrate through from holes 14A to holes 14B. In this case, the pattern of each of internal electrodes 16 is preferably configured in such a manner that: The area of the pattern that overlaps with hole 14A and hole 14B disposed for the corresponding via-hole electrodes to be coupled with the each of the internal electrodes, is set to be not larger than one-third of the area of each of hole 14A and hole 14B, as viewed from the stacking direction. With this configuration, the zinc oxide in varistor layer 12A can be smoothly etched, and internal electrodes 16 are formed so as to protrude from the layer of zinc oxide. This allows the improved connectivity between via-hole electrodes 15 and internal electrodes 16.

Note that, as described with reference to FIG. 3D, via-holes 20 may be formed by irradiating the product with laser light via holes 14A and 14B. Even in this process, it is possible to remove varistor layer 12A located between holes 14A and holes 14B to form via-holes 20. In this case, as described with reference to FIG. 3D, the pattern of each of internal electrodes 16 is preferably formed so as to cover hole 14A and hole 14B disposed for corresponding via-hole electrode 15 to be coupled with the respective one of internal electrodes 16, as viewed from the stacking direction. With this configuration, the connectivity is improved between internal electrodes 16 and via-hole electrodes 15.

Next, as shown in FIG. 4E, via-holes 20 are filled with a silver-palladium paste and then fired to form via-hole electrodes 15. Then, as shown in FIG. 4F, external electrodes 17 are formed on the surfaces of substrate 11A and substrate 13A so as to be coupled with via-hole electrodes 15. Moreover, as shown in FIG. 4G, semiconductor devices 18 are mounted on external electrodes 17 disposed on the surface of substrate 13A. Finally, the resulting product is divided into individual pieces by dicing. This completes ESD protector 30 with semiconductor device 18 mounted thereon, as shown in FIG. 4H. The steps from FIG. 4E to FIG. 4H are the same as those from FIG. 3E to FIG. 3H; therefore, detailed descriptions thereof are omitted.

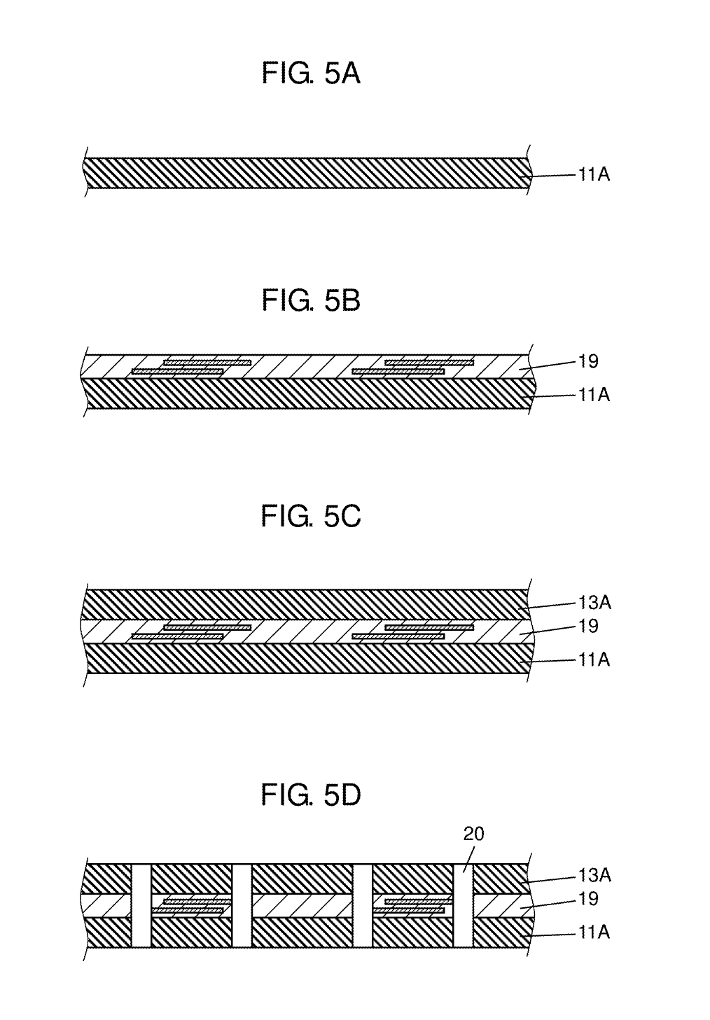

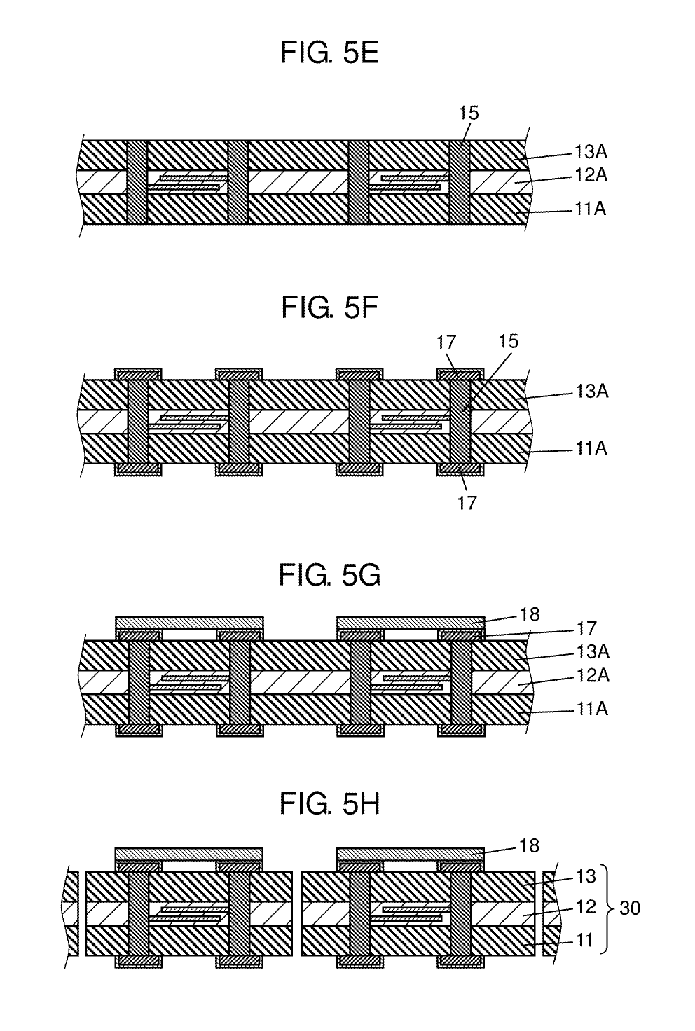

Next, descriptions will be made regarding further another method for manufacturing the electrostatic discharge (ESD) protector, according to the embodiment of the present invention. FIGS. 5A to 5H are views for illustrating the further another method for manufacturing the ESD protector, according to the embodiment of the invention.

First, as shown in FIG. 5A, substrate 11A is prepared that is an alumina plate with a thickness of approximately 0.14 mm. In substrate 11A, no through-hole is disposed.

Next, as shown in FIG. 5B, yet-to-be-fired layer 19 is formed on substrate 11A. Details of yet-to-be-fired layer 19 are the same as those described earlier.

Next, as shown in FIG. 5C, substrate 13A is laid on yet-to-be-fired layer 19, and then they are pressed together to form a stacked body in which substrate 11A, yet-to-be-fired layer 19, and substrate 13A are integrated. Note that substrate 13A is provided with no through-hole, as in the case of substrate 11A. In this way, substrates 11A and 13A have no through-hole; therefore, there is no need for aligning through-holes. This results in the simplified steps without misalignment.

Next, as shown in FIG. 5D, the resulting stacked body is irradiated with laser light to form via-holes 20 that penetrate through substrate 11A, yet-to-be-fired layer 19, and substrate 13A.

After that, the stacked body is placed in a furnace and yet-to-be-fired layer 19 is subjected to heat treatment to form varistor layer 12A. Then, as shown in FIG. 5E, via-holes 20 are filled with a silver-palladium paste, and then fired to form via-hole electrodes 15 that penetrate from the surface of substrate 11A to substrate 13A.

Next, as shown in FIG. 5F, external electrodes 17 are formed on the surfaces of substrate 11 and substrate 13 so as to be coupled with via-hole electrodes 15. Moreover, as shown in FIG. 5G, semiconductor devices 18 are mounted on external electrodes 17 that are disposed on the surface of substrate 13. Finally, the resulting product is divided into individual pieces by dicing. This completes ESD protector 30 with semiconductor device 18 mounted thereon, as shown in FIG. 5H. The steps from FIG. 5E to FIG. 5H are the same as those from FIG. 3E to FIG. 3H; therefore, detailed descriptions thereof are omitted.

In the manufacturing methods described above, substrate 11A is the same in thickness as substrate 13A; however, the thickness of substrate 11A (substrate 11) on which the light-emitting diodes are mounted may be larger than that of substrate 13A (substrate 13), as described with reference to FIG. 1. This configuration allows the improved reflectivity of the surface on which the light-emitting diodes are mounted.

Moreover, in the descriptions describe above, there are used substrate 11A n-fold larger in the planar dimension than substrate 11 and substrate 13A n-fold larger in the planar dimension than substrate 13. They are configured to include n-pieces of ESD protectors 30, and then the resulting product is divided into the individual pieces. This procedure is advantageous in productivity. However, a single piece of ESD protector 30 may be manufactured in the similar manner.

### INDUSTRIAL APPLICABILITY

In accordance with the present invention, the electrostatic discharge (ESD) protector featuring the small warpage and excellent heat conductivity can be manufactured, which is useful for industries.

### REFERENCE MARKS IN THE DRAWINGS

11 first high heat-conductive substrate
11A first high-heat-conductive large substrate
12, 12A varistor layer
13 second high heat-conductive substrate
13A second high-heat-conductive large substrate
14A, 14B through-hole
15 via-hole electrode
16 internal electrode
17 external electrode
18 semiconductor device
19 yet-to-be-fired layer
20 via-hole
30 electrostatic discharge (ESD) protector

1. An electrostatic discharge protector comprising:
a first high heat-conductive substrate including two of first through-holes;
a second high heat-conductive substrate including two of second through-holes;
a varistor layer disposed between the first high heat-conductive substrate and the second high heat-conductive substrate, the varistor layer including a pair of internal electrodes insulated from each other in an inside of the varistor layer, the varistor layer being mainly composed of zinc oxide;
a first via-hole electrode penetrating the varistor layer and filling both one of the first through-holes and one of the second through-holes to couple both the ones to each other, the first via-hole electrode being coupled with one of the internal electrodes; and
a second via-hole electrode penetrating the varistor layer and filling both the other of the first through-holes and the other of the second through-holes to couple both the others to each other, the second via-hole electrode being coupled with the other of the internal electrodes.

2. The electrostatic discharge protector according to claim 1, wherein the first and the second via-hole electrodes are disposed at positions most away from each other in a plane direction of the first high heat-conductive substrate.

3. The electrostatic discharge protector according to claim 1, wherein planar shapes of the first and second high heat-conductive substrates are rectangular, and the first and second via-hole electrodes are disposed at diagonal positions of the first high heat-conductive substrate.

4. The electrostatic discharge protector according to claim 1, wherein the pair of the internal electrodes includes a first internal electrode coupled with the first via-hole electrode and surrounding the second via-hole electrode, and a second internal electrode coupled with the first via-hole electrode and surrounding the first via-hole electrode.

5. A method for manufacturing an electrostatic discharge protector, the method comprising:
forming a yet-to-be-fired layer on a first high heat-conductive substrate including a plurality of first through-holes, the yet-to-be-fired layer being used for forming a varistor layer mainly composed of zinc oxide and including a pair of internal electrodes insulated from each other in an inside of the varistor layer;
bonding a second high heat-conductive substrate including a plurality of second through-holes to the first high heat-conductive substrate on an opposite side of the yet-to-be-fired layer;
forming via-holes penetrating the first high heat-conductive substrate, the yet-to-be-fired layer, and the second high heat-conductive substrate, by removing a part of the yet-to-be-fired layer located between the first through-holes and the second through-holes;
forming both the varistor layer sandwiched between the first high heat-conductive substrate and the second high heat-conductive substrate and the pair of the internal electrodes insulated from each other in the inside of the varistor layer, by firing the yet-to-be-fired layer after the via-holes are formed;
forming a first and a second via-hole electrodes coupled respectively with the pair of the internal electrodes, by filling a metal into the via-holes; and
forming external electrodes on each of the first high heat-conductive substrate and the second high heat-conductive substrate for being coupled respectively with the first and the second via-hole electrodes.

6. A method for manufacturing an electrostatic discharge protector, the method comprising the steps of:
forming a yet-to-be-fired layer on a first high heat-conductive substrate including a plurality of first through-holes, the yet-to-be-fired layer being used for foaming a varistor layer mainly composed of zinc oxide and including a pair of internal electrodes insulated from each other in an inside of the varistor layer;
bonding a second high heat-conductive substrate including a plurality of second through-holes to the first high heat-conductive substrate on an opposite side of the ye-to-be-fired layer;
forming both the varistor layer sandwiched between the first high heat-conductive substrate and the second high heat-conductive substrate and the pair of the internal electrodes insulated from each other in the inside of the varistor layer, by firing the yet-to-be-fired layer;
forming via-holes penetrating the first high heat-conductive substrate, the varistor layer, and the second high heat-conductive substrate, by removing a part of the varistor layer located between the first through-holes and the second through-holes;
forming a first and a second via-hole electrodes coupled respectively with the pair of the internal electrodes, by filling a metal into the via-holes; and
forming external electrodes on each of the first high heat-conductive substrate and the second high heat-conductive substrate for being coupled respectively with the first and the second via-hole electrodes.

7. A method for manufacturing an electrostatic discharge protector, the method comprising the steps of:
forming a stacked body by bonding
a first high heat-conductive substrate,
a yet-to-be-fired layer, and
a second high heat-conductive substrate in this order, the yet-to-be-fired layer being used for forming a varistor layer mainly composed of zinc oxide and including a pair of internal electrodes insulated from each other in an inside of the varistor layer;
forming a plurality of via-holes penetrating the first high heat-conductive substrate, the yet-to-be-fired layer, and the second high heat-conductive substrate, by irradiating the stacked body with laser light;
forming both the varistor layer sandwiched between the first high heat-conductive substrate and the second high heat-conductive substrate and the pair of the internal electrodes insulated from each other in the inside of the varistor layer, by firing the yet-to-be-fired layer;
forming a first and a second via-hole electrodes coupled respectively with the pair of the internal electrodes, by filling a metal into the via-holes; and
forming external electrodes on each of the first high heat-conductive substrate and the second high heat-conductive substrate for being coupled respectively with the first and second via-hole electrodes.
